(19) United States
(12) Patent Application Publication
(10) Pub. No.: US 2023/0304931 A1
(43) Pub. Date: Sep. 28, 2023

(54) METHOD FOR SENSING PLANT HORMONE USING HYDRAZINE DERIVATIVE, SENSOR USING THE SAME, AND METHOD FOR EARLY DETECTION OF PLANT DISEASE INFECTION

(71) Applicant: NEC Corporation, Minato-ku, Tokyo (JP)

(72) Inventor: Katsumi Maeda, Tokyo (JP)

(73) Assignee: NEC Corporation, Minato-ku, Tokyo (JP)

(21) Appl. No.: 18/018,661

(22) PCT Filed: Jul. 19, 2021
(86) PCT No.: PCT/JP2021/026961

§ 371 Date: Jan. 30, 2023

(30) Foreign Application Priority Data
Aug. 3, 2020 (JP) 2020-131537

(51) Int. Cl. G01N 21/64; G01N 31/22

(52) U.S. Cl. CPC G01N 21/64; G01N 31/22

(57) ABSTRACT

Provided is a method for sensing methyl jasmonate, which is a plant hormone released when a plant is damaged by an insect pest, in the cultivation of plants including agricultural crops, thereby providing a method for early and in-situ detection of a damage by an insect pest in a plant. More specifically, a hydrazine derivative that selectively recognizes methyl jasmonate, which is a plant hormone released released when a plant is damaged by an insect pest, is used as a sensing receptor to form a hydrazone derivative, and a damage by an insect pest can be detected at an early stage by utilizing the fluorescence emission phenomenon after reaction with methyl jasmonate.

### TECHNICAL FIELD

The present invention relates to a method for sensing methyl jasmonate, which is a plant hormone released when a plant is damaged by an insect pest, and a method for early detection of damage by an insect pest in a plant.

### BACKGROUND ART

It is known that plants have their own defense mechanisms that work against infection by pathogens such as filamentous fungi, feeding damage by insect pests and others, and stress due to environmental changes. Specifically, when plants are infected by pathogens, they synthesize salicylic acid, a signal substance, in the infected tissue. Then, salicylic acid moves through the plant body via the sieve tube tissue and induces defense mechanisms in uninfected tissues, resulting in the development of systemic resistance to pathogens (systemic acquired resistance). Also, when plants undergo feeding damage by insect pests, they synthesize ethylene and jasmonic acid, which, in the same manner as salicylic acid, move through the plant body and induce defense mechanisms systemically (induced systemic resistance). Furthermore, it is known that plants adapt to environmental stress by synthesizing abscisic acid in the plant body in response to changes in the growth environment, such as drought, low temperature, and salt damage.

It is also known that, when plants are infected by pathogens or undergo feeding damage by insect pests, they have a mechanism to inform not only the damaged plants themselves but also the surrounding plants (Non-Patent Document 1). Specifically, salicylic acid, which is synthesized when infected by pathogens, is methylated to be methyl salicylate, which is released from the plants as a volatile signal substance to inform the surrounding plants of the pathogen infection, thus promoting defense mechanisms in advance. Jasmonic acid, which is synthesized at the time of damage by insect pests, is also known to be methylated to be methyl jasmonate, which is a volatile signal released from the plants, inducing resistance in the surrounding plants in advance.

As described above, it is known that plants release plant hormones as signal substances when they are damaged by diseases and insect pests, and sensing such signal substances as quickly as possible makes possible early detection of damage by diseases and insect pests.

As the method for early discovery of damage by sensing methyl jasmonate released as a volatile signal at the time of insect pest damage, a method is disclosed in which a monitor plant with a luminescent protein gene is cultivated alongside a cultivated crop, and a phenomenon is utilized in which the monitor plant senses methyl jasmonate released and emits light when the crop undergoes damage by insect pests (Patent Document 1).

### CITATION LIST

### Patent Document

Patent Document 1: International Publication No. WO2019/082942

### Non-Patent Document

Non-Patent Document 1: J. Japan Association on Odor Environment, Vol. 36, No. 3, 153-155(2005).

### SUMMARY OF INVENTION

### Technical Problem

An object of the present invention is to provide a method for sensing methyl jasmonate, which is a plant hormone released when a plant is damaged by an insect pest, in the cultivation of plants including crops, as well as such a sensor, thereby providing a method for early, in-situ detection of damage by an insect pest in a plant.

### Solution to Problem

The present invention utilizes a hydrazine derivative that selectively reacts with methyl jasmonate, which is a volatile plant hormone, and forms a hydrazone derivative, as a receptor for a sensor. Also, the present invention detects damage by an insect pest in a plant at an early stage by utilizing a fluorescence emission phenomenon of a hydrazone derivative produced by a reaction of methyl jasmonate and a hydrazine derivative.

### Advantageous Effect of Invention

By using a hydrazine derivative, methyl jasmonate, a volatile plant hormone released when a plant is damaged by an insect pest, can be selectively sensed, and furthermore, damage by an insect pest in a plant can be detected at an early stage by utilizing a fluorescence emission phenomenon from a hydrazone derivative formed by a reaction of methyl jasmonate and a hydrazine derivative.

### BRIEF DESCRIPTION OF DRAWINGS

FIG. 1 are photographs showing the results of confirming whether or not fluorescence emission is observed by exposing to UV lamp light (wavelength 365 nm) a filter paper on which (a) 4-hydrazino-7-nitro-2,1,3-benzoxadiazole hydrazine (NBD-H) alone and (b) NBD-H+methyl jasmonate have been dropped, respectively.

FIG. 2 are photographs showing the results of confirming whether or not fluorescence emission is observed by exposing to UV lamp light (wavelength 365 nm) a filter paper on which (a) NBD-H alone and (b) NBD-H+methyl salicylate have been dropped, respectively.

FIG. 3 is a photograph showing the results of confirming whether or not fluorescence emission is observed by exposing to UV lamp light (wavelength 365 nm) (a) an ethanol solution of NBD-H, (b) an ethanol solution of NBD-H+an ethanol solution of methyl jasmonate, and (b) an ethanol solution of NBD-H+an ethanol solution of methyl salicylate, respectively.

### DESCRIPTION OF EMBODIMENTS

Hereinafter, embodiments of the present invention will be described with reference to the accompanying drawings and others. However, while the embodiments mentioned below have technically preferred limitations for implementing the present invention, they are not intended to limit the scope of the invention to those described below.

The present inventors have conducted diligent studies in order to solve the above-mentioned problem. As a result, they have found that methyl jasmonate, which is a volatile signal substance released when a plant is damaged by an insect pest, can be selectively sensed by using a hydrazine derivative, thus completing the present invention.

Hereinafter, embodiments according to the present invention will be described in detail.

### <Receptor for Methyl Jasmonate: Hydrazine Derivative>

Examples of the hydrazine derivative that may be used as a receptor for sensing methyl jasmonate include, but are not limited to, 4-hydrazino-7-nitro-2,1,3-benzoxadiazole hydrazine (NBD-H), 5-dimethylaminonaphthalene-1-sulfonyl hydrazine (Dansyl Hydrazine), 4-(N,N-dimethylaminosulfonyl)-7-hydrazino-2,1,3-benzoxadiazole (DBD-H) and the like.

For example, NBD-H reacts with methyl jasmonate (MJA) to generate a hydrazone derivative as shown in the following formula (1) and can selectively recognize methyl jasmonate.

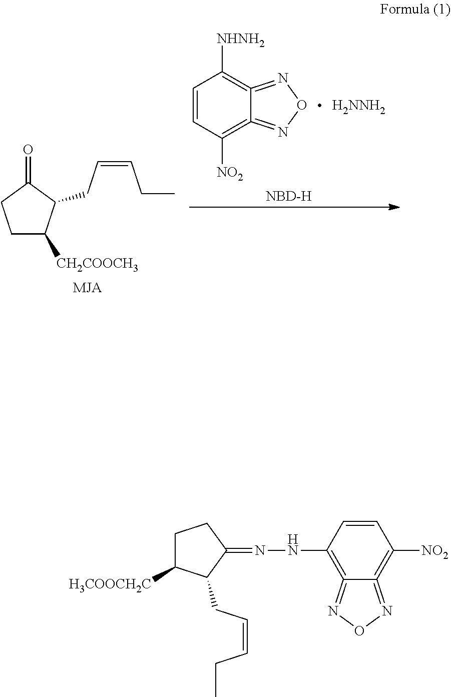

Accordingly, some embodiments of the present invention relate to a method for detecting methyl jasmonate, comprising allowing a hydrazine derivative to react with methyl jasmonate to form a hydrazone derivative. Some embodiments of the present invention relate to a method for sensing methyl jasmonate, using a hydrazine derivative as a receptor that selectively recognizes methyl jasmonate.

In some embodiments, 4-hydrazino-7-nitro-2,1,3-benzoxadiazole hydrazine is used as the hydrazine derivative.

In some embodiments, the reaction of the hydrazine derivative and hydrazine derivative is carried out in a solution. The solution may be, but is not limited to, an ethanol solution, an acetonitrile solution or a methanol solution, for example. In some embodiments, the concentration of the hydrazine derivative having a structure represented by general formula (1) may be, for example, in the range of 0.00001 mol/L to 5 mol/L, such as in the range of 0.00004 mol/L to 1 mol/L.

In some embodiments, the reaction of the hydrazine derivative and methyl jasmonate is carried out in a solid medium containing the hydrazine derivative. The solid medium may be, but is not limited to, paper or glass (for example, glass fiber, porous glass substrates, and the like), or resin (for example, polymethyl methacrylate, polyethylene, polypropylene, polyvinyl chloride, polystyrene, nylon resin, polyamide, polycarbonate, polyethylene terephthalate, polybutylene terephthalate, and polyphenylene oxide), water-soluble polymer (for example, cellulose-based polymer, agarose, starch-based polymer, sodium arginate, acrylate-based polymer, acrylamide-based polymer, polyvinyl alcohol, polyethylene oxide, polyvinylpyrrolidone, and the like).

### <Fluorescence Emission Phenomenon>

The hydrazone derivative produced by the reaction of the hydrazine derivative and methyl jasmonate newly exhibits fluorescence emission. Specifically, the hydrazone derivative formed by a reaction of a hydrazine derivative and methyl jasmonate exhibits fluorescence emission by exposing it to excitation light with a wavelength of 250 to 500 nm. On the other hand, the hydrazine derivative alone shows almost no fluorescence emission, which makes it possible to detect methyl jasmonate.

Thus, some embodiments of the present invention relate to a method for detecting methyl jasmonate, comprising: (i) a step of allowing a hydrazine derivative to react with methyl jasmonate to form a hydrazone derivative, (ii) a step of exposing the hydrazone derivative to excitation light, (iii) a step of detecting fluorescence emitted by the hydrazone derivative. In some embodiments, an appropriate wavelength within the range of 250 to 500 nm is selected as the excitation wavelength. Further, in some embodiments, a step of comparing the intensity of the detected fluorescence with a predetermined reference value to determine the concentration of methyl jasmonate may also be performed.

Some embodiments of the present invention relate to a method for sensing methyl jasmonate, utilizing a phenomenon in which methyl jasmonate reacts with a hydrazine derivative to form a hydrazone derivative, resulting in fluorescence emission.

In some embodiments, the method for sensing methyl jasmonate of the present invention may be used for detecting damage by an insect pest in a crop.

### <Methyl Jasmonate Sensor>

A methyl jasmonate sensor of the present invention using a hydrazine derivative as a receptor comprises at least a recognition section for methyl jasmonate and a detection section that detects recognition of methyl jasmonate by the recognition section. The recognition section at least comprises a hydrazine derivative, which is a receptor. The hydrazine derivative does not react with or recognize other plant hormones other than methyl jasmonate, such as methyl salicylate, and can therefore selectively recognize methyl jasmonate. The detection section is configured to be able to optically detect recognition of methyl jasmonate by the recognition section for methyl jasmonate. For example, the optical detection section comprises at least an excitation light source and a detection element in order to detect fluorescence emission of a hydrazone derivative produced by the hydrazine derivative and methyl jasmonate, and detects methyl jasmonate and measures the concentration thereof based on a change in fluorescence intensity.

Thus, some embodiments of the present invention relate to a methyl jasmonate sensor for detecting methyl jasmonate, at least comprising: a recognition section for methyl jasmonate that comprises a hydrazine derivative, which is a receptor that selectively recognizes methyl jasmonate; and a detection section that detects recognition of methyl jasmonate by the recognition section. In some embodiments, the methyl jasmonate sensor of the present invention detects methyl jasmonate, which is a plant hormone released when a crop is damaged by an insect pest. Thus, the methyl jasmonate sensor of the present invention may be used as a sensor for detecting damage by an insect pest in a crop. In some embodiments, the methyl jasmonate sensor of the present invention can selectively detect methyl jasmonate compared to methyl salicylate.

Some embodiments of the present invention relate to a methyl jasmonate sensor for detecting methyl jasmonate, at least comprising: (i) a recognition section for methyl jasmonate that comprises a hydrazine derivative; and (ii) a detection section that optically detects recognition of methyl jasmonate by the recognition section. In some embodiments, the optical detection section at least comprises an excitation light source and a detection element. In some embodiments, the methyl jasmonate sensor of the present invention can detect methyl jasmonate and/or measure the concentration thereof based on a change in the observed fluorescence intensity.

In some embodiments, the detection section may comprise a computer that executes a program to process detection of methyl jasmonate and/or measurement of the concentration thereof. Such a program may be, for example, a program that causes the computer to execute a step of receiving a signal from the optical detection element, a step of analyzing the received signal to determine the presence or absence of methyl jasmonate and/or the concentration thereof, and a step of outputting the analysis result.

In some embodiments, the analysis of the received signal may include comparing the received signal with a predetermined reference value to determine the presence or absence of methyl jasmonate and/or the concentration thereof, for example. In some embodiments, the analysis result may be output to, for example, a display device connected to the sensor, or other equipment or the like connected via a network.

Thus, some embodiments of the present invention relate to a program in a methyl jasmonate sensor for detecting methyl jasmonate, the methyl jasmonate sensor at least comprising: a recognition section for methyl jasmonate that comprises a hydrazine derivative, which is a receptor that selectively recognizes methyl jasmonate; and a detection section that detects recognition of methyl jasmonate by the recognition section, the detection section comprising a detection element and a computer, wherein the program causes the computer to execute: (i) a step of receiving a signal from the optical detection element; (ii) a step of analyzing the received signal to determine the presence or absence of methyl jasmonate and/or the concentration thereof; and (iii) a step of outputting the analysis result.

### <Method for Early Detection of Damage by Insect Pest in Crop>

As one application of the methyl jasmonate sensor of the present invention, by installing the methyl jasmonate sensor near where a crop is planted and detecting methyl jasmonate by the sensor, it is possible to detect damage by an insect pest in the crop at an early stage.

Thus, some embodiments of the present invention relate to a method for detecting damage by an insect pest in a crop, comprising installing a methyl jasmonate sensor in the vicinity of the crop, and detecting methyl jasmonate by the sensor. In some embodiments, the methyl jasmonate sensor is a methyl jasmonate sensor at least comprising: a recognition section for methyl jasmonate that comprises a hydrazine derivative, which is a receptor that selectively recognizes methyl jasmonate; and a detection section that detects recognition of methyl jasmonate by the recognition section. In some embodiments, the methyl jasmonate sensor is a methyl jasmonate sensor at least comprising: (i) a recognition section for methyl jasmonate that comprises hydrazine derivative; and (ii) a detection section that optically detects recognition of methyl jasmonate by the recognition section.

Examples of the crop that may be the monitoring target include, but are not limited to, cucumber, watermelon, tomato, eggplant, green pepper, paprika, shishito pepper, melon, Chinese cabbage, cabbage, radish, lettuce, leek, broccoli, onion, garlic, Japanese yam, asparagus, carrot, potato, celery, tobacco, rice, and strawberry.

Examples of the damage by an insect pest that may be detected include, but are not limited to, those caused by aphids, whiteflies, thrips, ladybugs, weevils, Helicoverpa armigeras, leafminers, spider mites, and tomato russet mites.

In the context of the present disclosure, when referring to installing the sensor in the vicinity of the crop, examples of the term “vicinity” include, but are not limited to, a distance within 2 m, within 1 m, within 75 cm, within 50 cm, within 40 cm, within 30 cm, within 20 cm, within 10 cm, or within 5 cm of the crop to be monitored, and an appropriate distance is selected as appropriate in consideration of a variety of factors. A person skilled in the art would be able to set the position of the sensor to be installed as appropriate in consideration of a variety of conditions.

Some embodiments of the present invention relate to the use of the methyl jasmonate sensor in detection of damage by an insect pest in a crop. Some embodiments of the present invention relate to use of a hydrazine derivative in production of the methyl jasmonate sensor.

### <Receptor for Methyl Jasmonate>

Some embodiments of the present invention relate to the use of the hydrazine derivative that reacts with methyl jasmonate to produce a compound which exhibits fluorescence emission, as a receptor for methyl jasmonate. Specifically, a hydrazone derivative formed by a reaction of the hydrazine derivative and methyl jasmonate exhibits fluorescence emission by exposing it to excitation light with a wavelength of 250 to 500 nm. In another aspect, some embodiments of the present invention relate to a receptor for methyl jasmonate that consists of or comprises the hydrazine derivative. Some embodiments of the present invention are characterized by the use of the hydrazine derivative as a receptor that selectively recognize methyl jasmonate.

In some embodiments of the present invention, the hydrazine derivative that may be used include at least one compound selected from the group consisting of 4-hydrazino-7-nitro-2,1,3-benzoxadiazole hydrazine, 5-dimethylaminonaphthalene-1-sulfonylhydrazine, and 4-(N,N-dimethylaminosulfonyl)-7-hydrazino-2,1,3-benzoxadiazole.

### EXAMPLES

Hereinafter, an embodiment of the present invention will be explained in details by using examples, but the present invention is not limited to these examples.

### Example 1

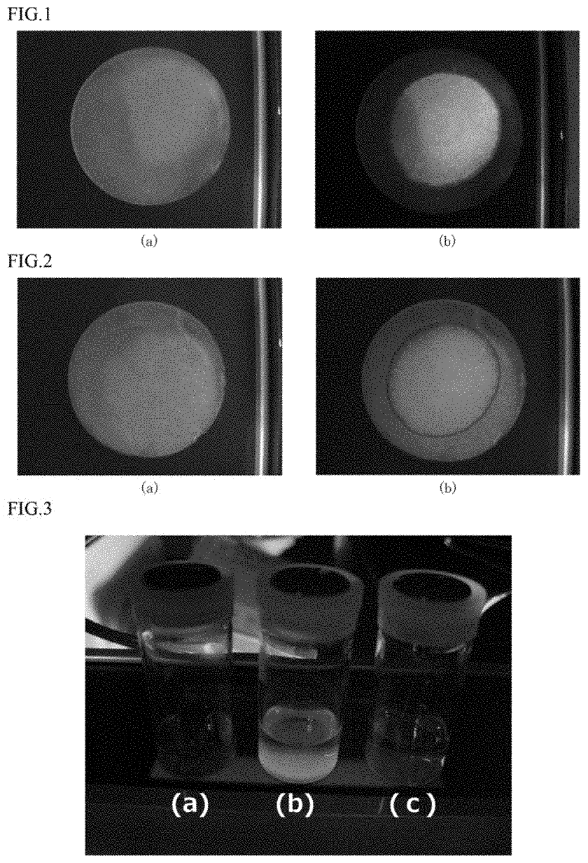

A solution obtained by dissolving 0.0091 g of 4-hydrazino-7-nitro-2,1,3-benzoxadiazole hydrazine (NBD-H) in 20 ml of acetonitrile solution containing 0.025% of trifluoroacetic acid was dropped on a circular filter paper (45 mmΦ) and dried to obtain a filter paper containing NBD-H. The obtained filter paper was excited with a UV lamp (wavelength 365 nm) to confirm whether fluorescence emission was present (FIG. 1(a)). Next, 0.03 ml of an acetonitrile solution (0.1 mol/L) of methyl jasmonate (MJA), which is released when a plant is damaged by an insect pest, was dropped on that filter paper and dried, and the obtained filter paper was similarly excited with a UV lamp to confirm whether fluorescence emission was present (FIG. 1(b)). As a result, it was found that NBD-H alone does not exhibit fluorescence emission, but NBD-H reacts with methyl jasmonate to exhibit fluorescence emission, indicating that methyl jasmonate can be sensed.

### Comparative Example 1

A solution obtained by dissolving 0.0091 g of 4-hydrazino-7-nitro-2,1,3-benzoxadiazole hydrazine (NBD-H) in 20 ml of acetonitrile solution containing 0.025% of trifluoroacetic acid was dropped on a circular filter paper (45 mmΦ) and dried to obtain a filter paper containing NBD-H. The obtained filter paper was excited with a UV lamp (wavelength 365 nm) to confirm whether fluorescence emission was present (FIG. 2(a)). Next, 0.03 ml of an acetonitrile solution (0.1 mol/L) of methyl salicylate (MSA), which is released when a plant is infected by a pathogen, was dropped on that filter paper and dried, and the obtained filter paper was similarly excited with a UV lamp to confirm whether fluorescence emission was present (FIG. 2(b)). As a result, it was found that NBD-H does not react with methyl salicylate and not exhibit fluorescence emission.

From the results of Example 1 and Comparative Example 1, it was found that NBD-H can selectively sense methyl jasmonate, which is released by a plant at the time of damage by an insect pest.

### Example 2

0.0091 g of 4-hydrazino-7-nitro-2,1,3-benzoxadiazole hydrazine (NBD-H) was dissolved in 20 ml of acetonitrile solution containing 0.025% trifluoroacetic acid to prepare a NBD-H solution. Next, 2 ml of NBD-H solution was put into the sample bottle, (a) without adding anything else, (b) with adding 0.04 ml of acetonitrile solution of MJA (0.1 mol/L), and (c) with adding 0.04 ml of an acetonitrile solution of MSA (0.1 mol/L). The obtained three kinds of solutions were excited with a UV lamp (wavelength: 365 nm) to confirm whether fluorescence emission was present (FIG. 3). As a result, it was found that the NBD-H alone solution (a) and the solution with added MSA (c) did not exhibit fluorescence emission, but the solution with added MJA (b) showed yellow fluorescence emission, indicating that methyl jasmonate can be sensed.

The whole or part of the example embodiments disclosed above can be described as, but not limited to, the following supplementary notes.

### Supplementary Note 1

A sensing method for sensing methyl jasmonate, using a hydrazine derivative as a receptor that selectively recognizes methyl jasmonate.

### Supplementary Note 2

The sensing method according to Supplementary note 1, wherein the hydrazine derivative is any of 4-hydrazino-7-nitro-2,1,3-benzoxadiazole hydrazine, 5-dimethylaminonaphthalene-1-sulfonylhydrazine, and 4-(N,N-dimethylaminosulfonyl)-7-hydrazino-2,1,3-benzoxadiazole.

### Supplementary Note 3

The sensing method according to any one of Supplementary notes 1 to 2, wherein the sensing utilizes a phenomenon in which methyl jasmonate reacts with the hydrazine derivative to form a hydrazone derivative and exhibit fluorescence emission.

### Supplementary Note 4

A methyl jasmonate sensor for detecting methyl jasmonate, at least comprising:
i) a recognition section for methyl jasmonate that comprises a hydrazine derivative; and
ii) a detection section that detects recognition of methyl jasmonate by the recognition section.

### Supplementary Note 5

A method for detecting pest damage to a crop, comprising installing the methyl jasmonate sensor according to Supplementary note 4 in a vicinity of the crop, and detecting methyl jasmonate by the sensor.

### Supplementary Note 6

A methyl jasmonate sensor for detecting methyl jasmonate, at least comprising: a recognition section for methyl jasmonate that comprises a hydrazine derivative, which is a receptor that selectively recognizes methyl jasmonate; and a detection section that detects recognition of methyl jasmonate by the recognition section; the detection section comprising an optical detection element and a computer, and the methyl jasmonate sensor comprising a program, wherein the program causes the computer to execute:
i) receiving a signal from the optical detection element;
ii) analyzing the received signal to determine presence or absence of methyl jasmonate and/or a concentration thereof; and
iii) outputting an analysis result.

### Supplementary Note 7

A program to control a methyl jasmonate sensor for detecting methyl jasmonate, the methyl jasmonate sensor at least comprising: a recognition section for methyl jasmonate that comprises a hydrazine derivative, which is a receptor that selectively recognizes methyl jasmonate; and a detection section that detects recognition of methyl jasmonate by the recognition section; the detection section comprising an optical and/or electrochemical detection element and a computer, wherein the program causes the computer to execute:
i) receiving a signal from the optical and/or electrochemical detection element;
ii) analyzing the received signal to determine presence or absence of methyl jasmonate and/or a concentration thereof; and
iii) outputting an analysis result.

### Supplementary Note 8

A detection method for detecting methyl jasmonate, comprising: (i) allowing a hydrazine derivative to react with methyl jasmonate to form a hydrazone derivative; (ii) exposing the hydrazone derivative to excitation light; and (iii) detecting fluorescence emitted by the hydrazone derivative.

### Supplementary Note 9

The detection method according to Supplementary note 8, wherein a wavelength in a range of 250 to 500 nm is used as the excitation wavelength.

### Supplementary Note 10

The detection method according to Supplementary note 8 or 9, further comprising comparing an intensity of the detected fluorescence with a predetermined reference value to determine a concentration of methyl jasmonate.

### Supplementary Note 11

The detection method according to any one of Supplementary notes 8 to 10, wherein the hydrazine derivative is at least one compound selected from the group consisting of 4-hydrazino-7-nitro-2,1,3-benzoxadiazole hydrazine, 5-dimethylaminonaphthalene-1-sulfonylhydrazine, and 4-(N,N-dimethylaminosulfonyl)-7-hydrazino-2,1,3-benzoxadiazole.

### Supplementary Note 12

A methyl jasmonate sensor for detecting methyl jasmonate, at least comprising:
i) a recognition section for methyl jasmonate that comprises a hydrazone derivative; and
ii) a detection section that optically detects recognition of methyl jasmonate by the recognition section.

### Supplementary Note 13

The methyl jasmonate sensor according to Supplementary note 12, wherein the optical detection section at least comprises an excitation light source and a detection element.

### Supplementary Note 14

A method for detecting pathogen infection in a crop, comprising installing the methyl jasmonate sensor according to Supplementary note 12 or 13 in a vicinity of the crop, and detecting methyl jasmonate by the sensor.

### Supplementary Note 15

The method for detecting pathogen infection in a crop according to Supplementary note 5 or 14, wherein the sensor is installed within 2 m from the crop.

### Supplementary Note 16

Use of a hydrazine derivative as a receptor for methyl jasmonate which reacts with methyl jasmonate to generate a compound that exhibits fluorescence emission.

### Supplementary Note 17

Use according to claim 7, wherein the hydrazine derivative is any of 4-hydrazino-7-nitro-2,1,3-benzoxadiazole hydrazine, 5-dimethylaminonaphthalene-1-sulfonylhydrazine, and 4-(N,N-dimethylaminosulfonyl)-7-hydrazino-2,1,3-benzoxadiazole.

### INDUSTRIAL APPLICABILITY

The sensing according to embodiments of the present invention in which a hydrazine derivative is used as a receptor for detecting methyl jasmonate, which is a plant hormone, selectively reacts with methyl jasmonate and also develops a fluorescence emission phenomenon, and thus enables selective detection of methyl jasmonate, which is a plant hormone released when a plant is damaged by an insect pest.

By using a sensor in which the hydrazine derivative serves as the recognition section, damage by an insect pest in a plant can be detected at an early stage, and specifically, as a sensor that can detect damage by an insect pest of a crop at an early stage, it can be used as a novel sensor for agricultural ICT in greenhouses and other horticultural facilities.

What is claimed is:

1. A sensing method for sensing methyl jasmonate, using a hydrazine derivative as a receptor that selectively recognizes methyl jasmonate.

2. The sensing method according to claim 1, wherein the hydrazine derivative is any of 4-hydrazino-7-nitro-2,1,3-benzoxadiazole hydrazine, 5-dimethylaminonaphthalene-1-sulfonylhydrazine, and 4-(N,N-dimethylaminosulfonyl)-7-hydrazino-2,1,3-benzoxadiazole.

3. The sensing method according to claim 1, wherein the sensing utilizes a phenomenon in which methyl jasmonate reacts with the hydrazine derivative to form a hydrazone derivative and exhibit fluorescence emission.

4. A methyl jasmonate sensor for detecting methyl jasmonate, at least comprising:
i) a recognition section for methyl jasmonate that comprises a hydrazine derivative; and
ii) a detection section that detects recognition of methyl jasmonate by the recognition section.

5. A method for detecting pest damage to a crop, comprising installing the methyl jasmonate sensor according to claim 4 in a vicinity of the crop, and detecting methyl jasmonate by the sensor.

6. The A methyl jasmonate sensor for detecting methyl jasmonate according to claim 4, at least comprising: a recognition section for methyl jasmonate that comprises a hydrazine derivative, which is a receptor that selectively recognizes methyl jasmonate; and a detection section that detects recognition of methyl jasmonate by the recognition section; the detection section comprising an optical detection element and a computer, and the methyl jasmonate sensor comprising a program, wherein the program causes the computer to execute:
i) receiving a signal from the optical detection element;
ii) analyzing the received signal to determine presence or absence of methyl jasmonate and/or a concentration thereof; and
iii) outputting an analysis result.

7. (canceled)

8. (canceled)
